(19) United States
(12) Patent Application Publication
(10) Pub. No.: US 2013/0097122 A1
(43) Pub. Date: Apr. 18, 2013

(54) Temporary File Storage System and Method

(71) Applicant: Jeffrey Liem, Chicago, IL (US)

(72) Inventor: Jeffrey Liem, Chicago, IL (US)

(21) Appl. No.: 13/650,351

(22) Filed: Oct. 12, 2012

Related U.S. Application Data
(60) Provisional application No. 61/546,231, filed on Oct. 12, 2011.

(51) Int. Cl. G06F 7/00; G06F 17/30

(52) U.S. Cl. 707/689; 707/E17.005; 707/E17.032

(57) ABSTRACT

The present disclosure relates to occasions when a sender wishes to submit a file to a web server or the like with assurance the file will be temporarily posted and then systematically deleted in a secure manner, where it would not be possible for others to recover the file or data associated with the file, such as information that can be used to identify the sender. The disclosure includes, for example, a computerized system for temporarily storing files, including at least one computer. The computer may be configured to receive a file, store the file, allow the file to be accessed over a network, and securely delete the file when a rule defining when the file is to be securely deleted has been satisfied.

### CROSS REFERENCES TO RELATED APPLICATIONS

This application claims the benefit of U.S. Provisional Patent Application Ser. No. 61/546,231, filed on Oct. 12, 2011, the contents of which are incorporated herein by reference in their entirety.

### FIELD

The present disclosure relates to systems and methods for temporarily storing files. In particular, the present disclosure relates to systems and methods for posting a file and securely deleting the file after a pre-specified condition, or set of conditions, have been met.

### BACKGROUND

Methods for submitting, storing and deleting files are well known in the art. For example, www.facebook.com and other popular social media websites and applications permit persons to upload image files, such as .jpg or .tif files, which are then stored by a server and eventually posted for others to access.

There are occasions when the person or user who submitted the file (hereinafter, the “sender”) may submit a “delete” request (by clicking on a “delete” menu item or the like) because the sender no longer desires to have their file posted. Under conventional methods, the server performs an operation that causes the sender's file to no longer be visible or readily accessible by others. In most cases, however, the file is not truly deleted and can be recovered and accessed by website operators, computer hackers and others, often with little effort.

There are other occasions where a witness may have an opportunity to take a photograph of suspicious activity with a smart phone and transmit the image or other information to law enforcement authorities. Yet, the witness may be reluctant to do so without some assurance of anonymity.

### SUMMARY

The present disclosure relates to occasions when a sender wishes to submit a file to a web server or the like with assurance the file will be temporarily posted and then deleted in a secure manner, where it would not be possible for others to recover the file or data associated with the file, such as information that can be used to identify the sender. Such an occasion may arise, for example, when a someone in an airport terminal observes a suspicious person and wishes to use a mobile phone or the like to anonymously email a photo image of the suspect to airport security. In this scenario, the sender may want assurance that information identifying him/her—and, in many cases, the image file itself—will be securely deleted after being stored and posted temporarily.

In an illustrative embodiment, a system includes, among other things, a sender, an administrator, a server, an application executable by a processor, and a website. In an embodiment, the sender submits a file to the server operated by an administrator or website operator who sets configurations, such as the deletion conditions, which are accessed by the application executed by the processor. The application temporarily posts the file, and in some instances temporarily makes the file available for download by others accessing the website. The application then securely deletes the file and may also discard or securely delete information that may be used to discover the source of the file, including, for example, the identity of the sender. Secure deletion may be accomplished using secure deletion algorithms well known in the art, including, for example, a UNIX/LINUX “SHRED” command.

In an illustrative embodiment, the system and method is a computerized system and method including a server and a processor configured to receive a file from a sender over a network, for example, the internet. The file may be sent in an email communication by the sender. Upon receiving the email communication, the processor opens the email communication and collects the file. The email communication—which may contain information identifying the source of the file, such as the sender's identity—may be discarded or securely deleted after the image file has been collected. The processor stores the file on the server or in a database in communication with the server. The file may be posted to a website that may be accessible over the network. The file is securely deleted when a rule defining when the file is to be securely deleted has been satisfied. In one embodiment, the file may be securely deleted by overwriting the file with random data. Additionally, in some embodiments any identifying information of the sender or other source information may also be securely deleted.

The rule may be a specified time limit, for example, a number of minutes, hours, days, weeks, and months. The rule may be a specified number of files that can be stored or posted. The rule may also be an administrator-defined rule in which the administrator of the website or server defines conditions for when the file is to be securely deleted.

The system and method may also limit access to the file posted on the website by only allowing registered users or subscribers to access and optionally download the file. The system and method may also limit which files are to be stored and/or posted to those files received from registered users or senders.

### BRIEF DESCRIPTION OF THE DRAWINGS

Embodiments of systems and methods are illustrated in the figures of the accompanying drawings which are meant to be exemplary and not limiting, in which like references are intended to refer to like or corresponding parts, and in which:

FIG. 1 illustrates a system overview according to an illustrative embodiment;

FIG. 2 illustrates a flow diagram of a system and method according to an illustrative embodiment;

FIG. 3 illustrates a flow diagram of processing and deleting files based on a number of files stored;

FIG. 4 illustrates a flow diagram of a subscriber-based application and deleting files based on a number of files stored;

FIG. 5 illustrates a flow diagram of a paid-for file sharing application and deleting files based on a number of files stored;

FIG. 6 illustrates a flow diagram of processing and deleting files based on a specified time limit;

FIG. 7 illustrates a flow diagram of subscriber-based application and deleting files based on a specified time limit; and

FIG. 8 illustrates a flow diagram of a paid for file sharing application and deleting files based on a specified time limit.

### DETAILED DESCRIPTION

Detailed embodiments of systems and methods are disclosed herein, however, it is to be understood that the disclosed embodiments are merely exemplary of the systems and methods, which may be embodied in various forms. Therefore, specific functional details disclosed herein are not to be interpreted as limiting, but merely as a basis for the claims and as a representative basis for teaching one skilled in the art to variously employ the present disclosure.

Generally, the systems and methods disclosed herein can include, and may be implemented, within a number of different devices and computer systems, including, for example, general-purpose computing systems, server-client computing systems, mainframe computing systems, a cloud computing infrastructure, telephone computing systems, laptop computers, desktop computers, smart phones, cellular phones, personal digital assistants (PDAs), tablet computers, and other mobile devices. The devices and computing systems may have one or more databases and other storage apparatuses, servers, and additional components, for example, processors, modems, terminals and displays, computer-readable media, algorithms, modules, and other computer-related components. The devices and computer systems and/or computing infrastructures are configured, programmed, and adapted to perform the functions and processes of the systems and methods as disclosed herein.

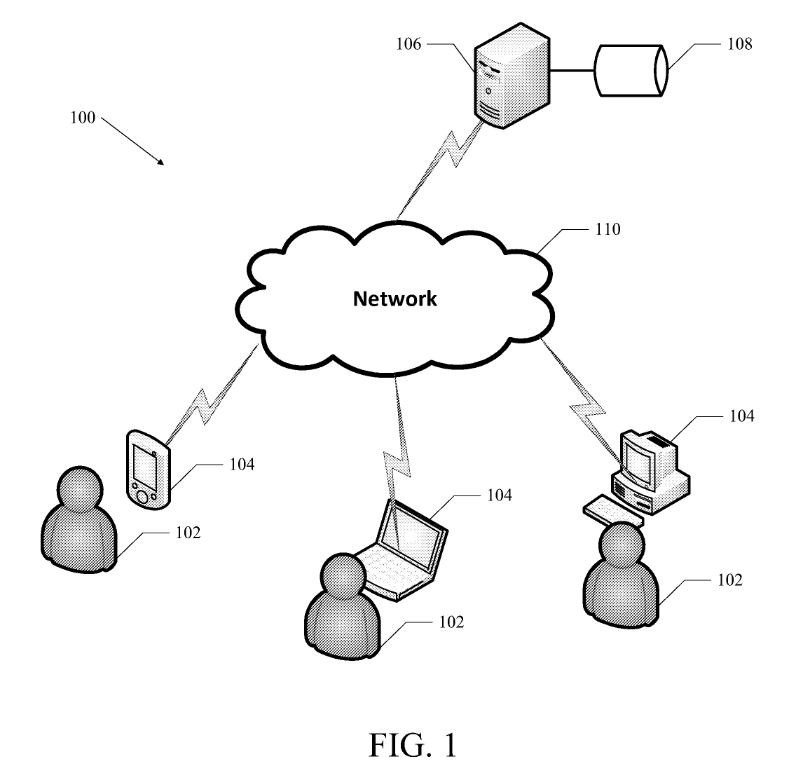

An overview of a system according to an illustrative embodiment is described with reference to FIG. 1. As illustrated in FIG. 1, the system 100 involves a user 102, and includes a local device 104 operable by the user 102, and a computer or server 106 in communication with the local device 104 over a network 110, which may be, for example, the Internet. The server 106, which may operate as a series of computers or servers, may also include one or more databases 108. In an illustrative embodiment, the user 102 can submit a file to the server 106 over the network 110 using the local device 104. The server 106 includes a processor configured to temporarily post the file to a website—and in some instances temporarily make the file available for download—accessible by users over the network 110. The processor is adapted to automatically securely delete the file, and may also securely delete information identifying the source of the file.

In one aspect, the server or processor is adapted to securely delete the file in a manner that renders the file unrecoverable. For example, the file may be securely deleted using a shred function, such as the shred functions found in Linux, FreeBSD, and other UNIX systems. The function may single out the file to be deleted and repeatedly overwrite the name and contents of the file with random or useless data. Other types of secure deletion functions may be used as well.

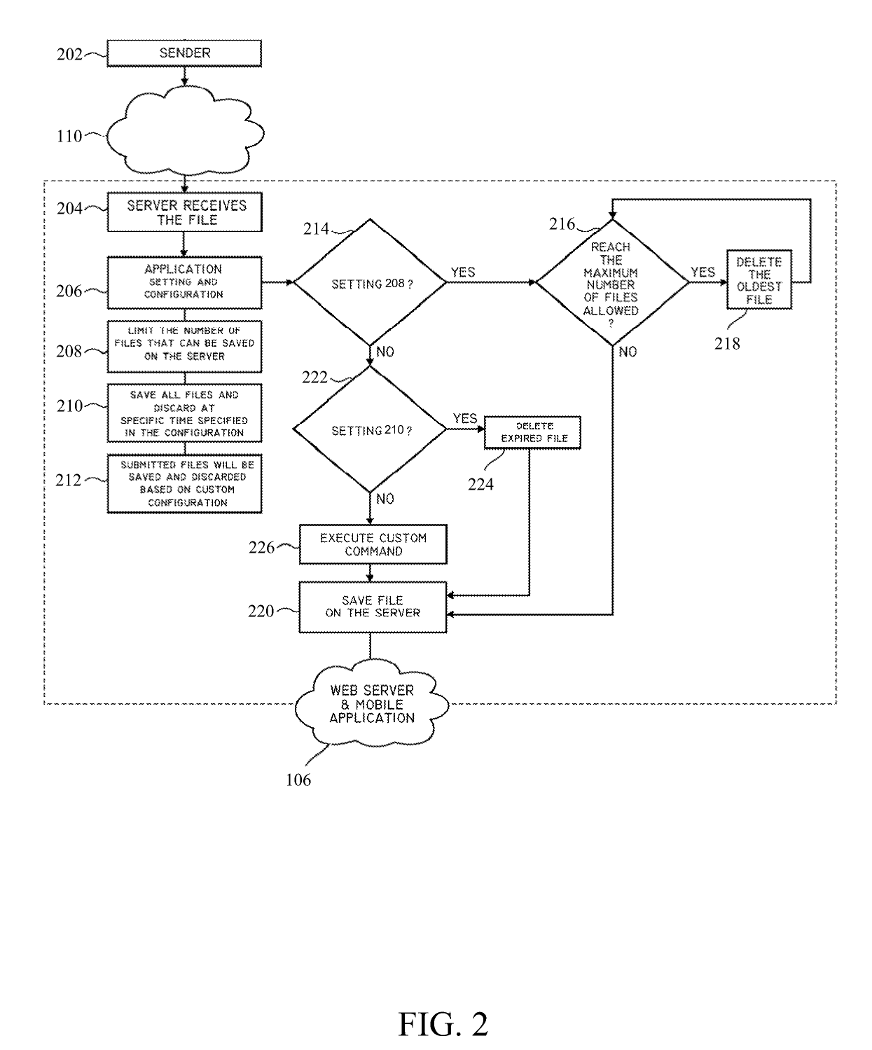

A flow diagram of a method according to an illustrative embodiment is described with reference to FIG. 2. For purposes of clarity, a user who is submitting a file to the server is referred to hereinafter as a “sender” 202. As illustrated in FIG. 2, the sender 202 sends a file over the network 110, for example, using the local device, to the server 106, which may, for example, be a web server. The server 106 receives the file, illustrated as 204. In one embodiment, the server 106 includes an application executable by a processor. Upon receiving the file, the processor executes the application and checks the setting and configuration established, which may be established, for example, by an administrator of the application, website, or server, illustrated as 206. As illustrated in FIG. 2, there are different options for setting or defining the rules that determine when the files are to be securely deleted. A first option limits the number of files that can be stored or posted on the server 106, illustrated as 208. A second option stores or posts the incoming files on the server 106 and securely discards or deletes the stored files at a specified time, for example, after a number of minutes, hours, days, weeks, etc, that the file has been stored or posted on the server 106, illustrated as 210. A third option is a customizable option that can be specified by, for example, an administrator. This option makes it possible to configure the system to securely delete or discard the file stored or posted on the server 106 based upon specified rules and/or events, illustrated as 212.

When a file is received by the server 106, the processor determines whether the first setting option is active, illustrated as 214. When the first setting option is active, the processor determines whether the maximum number of files allowed has been reached, illustrated as 216. When the maximum number of files allowed has been reached, the processor securely discards or deletes the oldest file stored on the server 106, illustrated as 218. When the maximum number of files allowed has not been reached, the processor stores the file on the server 106, illustrated as 220. The processor may also post the file to a website for users to access and view the file and optionally make the file available for download by users over the network 110.

When the first setting option is not active, the processor determines whether the second option is active, illustrated as 222. When the second setting option is active, the processor determines which files stored on the server 106 are expired or have been stored on the server 106 beyond the specified time limit. When the specified time limit has been reached, the processor securely discards or deletes the files that have been stored on the server 106 beyond the specified time limit, illustrated as 224. The processor also stores the received file on the server 106, illustrated as 220. The processor may also post the file to a website for users to access and view the file and optionally make the file available for download by users over the network 110.

When the second setting option is not active, the processor determines whether the third option is active. When the third setting option is active, the processor executes the customized option and securely discards or deletes the files stored on the server 106 in accordance with customized settings, illustrated as 226. The processor also stores the received file on the server 106, illustrated as 220. The processor may also post the file to a website for users to access and view the file and optionally make the file available for download by users.

The customized settings may include administrator specified rules that configure the processor to securely delete or discard the file stored or posted on the server 106. The rules may include a specified time limit, for example, a number of minutes, hours, days, weeks, etc, for the amount of time the file should be stored on the server 106 or posted on the website before being securely deleted. The rules may include a specified number of times the file can be viewed by users over the network 110, that when reached, the file is securely deleted. The rules may include a specified number of downloads, for example, a number of times the file can be downloaded by users over the network 110, that when reached, the file is securely deleted. The rules may include an anonymous posting, in which all information identifying the sender of the file is securely deleted upon the file being stored or posted or at another specified time. The rules may also be defined based on the type of website and the intended function and use of the website. For example, in a police security application, a police department administrator may be permitted to define the rules for when files or other information is securely deleted. Other rules may also be used based on the circumstances and type of the file being sent to the server 106. The website may also be operated by a third party, in which case a third party administrator determines the rules.

The system may also be equipped with additional security features well known in the art. Such features include, by way of example, utilities aimed at preventing users from being able to use a “right click” to download images and other files from the website.

There are a wide variety of applications for the systems and methods disclosed herein. These applications include, by way of example: (i) social networking websites where senders submit photographs; (ii) sporting websites where senders submit photographs taken during sporting events; (iii) art websites where senders submit photographs of art, and paintings and drawings created using digital painting and drawing applications; (iv) outdoor enthusiast websites where senders submit photographs and other files of outdoor activities, for example, hiking, hunting, fishing, boating, skiing, biking, and/or other outdoor activities; (v) animal aficionado websites where senders submit photographs and other files of pets and other animals, for example, dogs, cats, fish, birds, horses, and/or other animals; (vi) education websites where students submit audio files, video files, image files, and the like; (vii) security command centers and other law enforcement authorities where senders may submit photographs of suspicious activity; (viii) software vendor applications, where a software vendor submits software, for example, a video game software, to be temporarily accessed by users; (ix) media applications where senders submit audio files, video files, image files, and the like; (x) restaurant or retail applications, where owners/operators of the enterprise can temporarily post coupons, photographed images of coupons, “Daily Special” blackboards, and the like; and/or (xi) news reporting applications where senders can choose to anonymously submit photos and other images or materials.

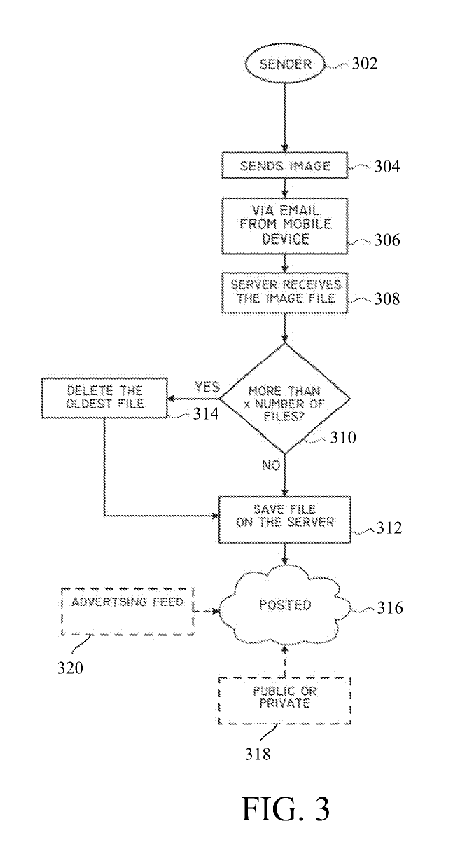

A flow diagram of processing and deleting files based on a number of files stored according to an illustrative embodiment is described with reference to FIG. 3. As illustrated in FIG. 3, a sender 302 may send a file, for example, an image, illustrated as 304, to the server. In this embodiment, the sender 302 sends the file in an email communication from a local device, for example, a mobile device, illustrated as 306. The server receives the file, illustrated as 308. The server or processor may also open the email communication and collect only the file in the email communication. The email communication may be discarded or securely deleted after the file has been collected.

The server or processor determines whether there are more than a specified number of files stored or posted on the server, illustrated as 310. If there are less than the specified number of files stored or posted on the server, the server or processor stores the file on the server, illustrated as 312. If there are more than the specified number of files stored or posted on the server, the server or processor securely deletes the oldest file on the server, illustrated as 314, and then stores the file on the server, illustrated as 312. The server or processor may also post the file to a website, illustrated as 316. The website may allow private or public access to the website by users, illustrated as 318. When the website is private, the website may require a user to log into the website in order to access the website and view or download the submitted file. In some embodiments, the website may receive and include advertising materials that are also posted on the website, illustrated as 320.

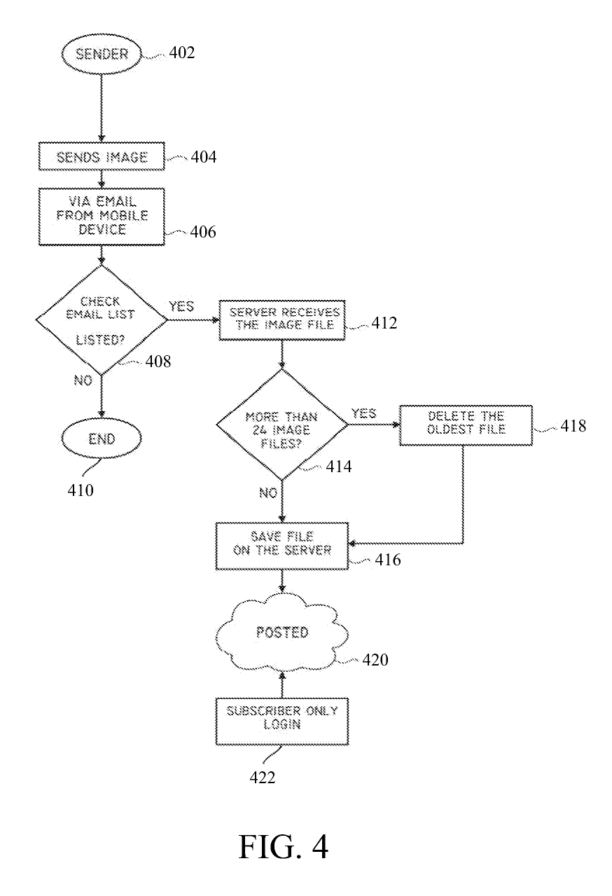

A flow diagram of a subscriber-based application according to an illustrative embodiment is described with reference to FIG. 4. This application may be useful where users or senders desire to limit access to the files posted, for example, to a certain group of users. As illustrated in FIG. 4, a sender 402 may send a file, for example, an image, illustrated as 404, to the server in an email communication from a local device, for example, a mobile device, illustrated as 406. In this embodiment, the server or processor determines whether the email address that the email communication was sent from is registered or listed in an email list, illustrated as 408. If the email address is not registered or listed in the email list, the server or processor does not receive the file and ends the process, illustrated as 410. If the email address is registered or listed in the email list, the server or processor receives and collects the file, illustrated as 412. The email communication, which may contain information identifying the source of the file, may be also discarded or securely deleted.

In the same manner as described above, the server or processor determines whether there are more than a specified number of files stored or posted on the server, in this embodiment twenty four files, illustrated as 414. If there are less than twenty four files on the server, for example, the server or processor stores the file on the server, illustrated as 416. If there are more than twenty four files on the server, the server or processor securely deletes the oldest file on the server, illustrated as 418, and the server or processor stores the file on the server, illustrated as 416. The server or processor may also post the file to a website, illustrated as 420. In this embodiment, the website is a private website, illustrated as 422, and only allows subscribers or registered users to access the posted files. The subscribers or registered users may access the posted files, for example, by entering secure login information. In some embodiments, the website may receive and include advertising materials that are also posed on the website.

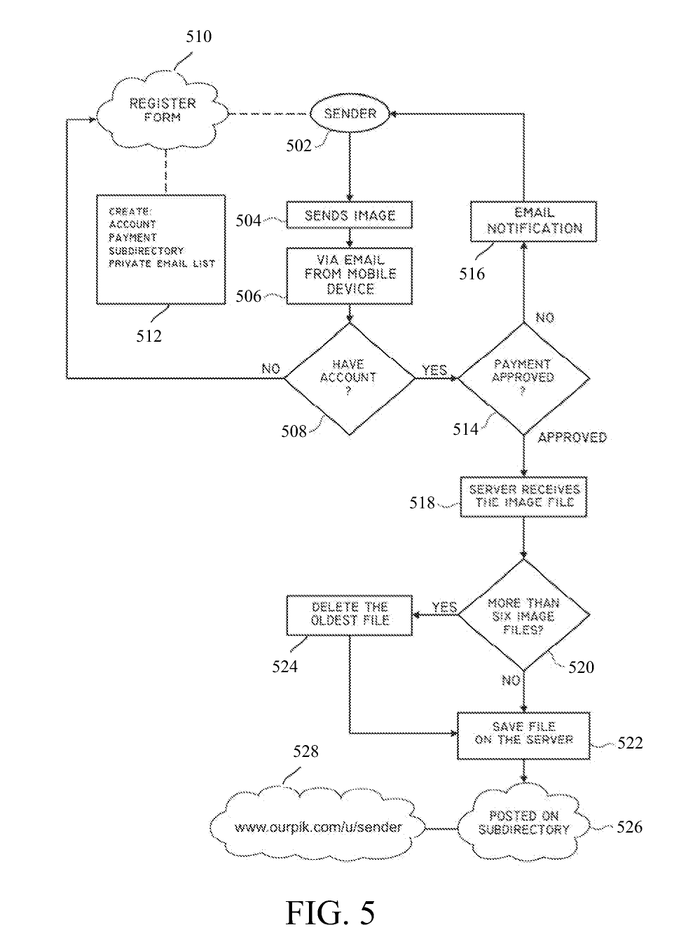

A flow diagram of a paid-for file sharing application and deleting files based on a number of files stored according to an illustrative embodiment is described with reference to FIG. 5. This embodiment may be useful in setting up personal photograph sharing websites. As illustrated in FIG. 5, a sender 502 may send a file, for example, an image, illustrated as 504, to the server in an email communication from a local device, for example, a mobile device, illustrated as 506. In this embodiment, the server or processor determines if the sender has an account on the server, illustrated as 508, for example, by determining if the email address that the email communication was sent from is registered under an account. If the sender does not have an account, the server or processor may prompt the sender to register by filling out a registration form, illustrated as 510. Upon registering, the server or processor may create an account for the sender, including a payment method provided by the sender, create a subdirectory for posting files submitted by the sender, and create a private email list that the sender can manage to allow access to files posted by the sender, illustrated as 512.

When the sender submits an image and has an account, the server or processor determines whether the sender's payment method on file is approved or processes in response to an electronic payment, illustrated as 514. If the payment is not approved, the server or processor may send an email notification to the sender, illustrated as 516. If the payment is approved, the server or processor receives and collects the file sent by the sender, illustrated as 518.

In the same manner as described above, the server or processor determines whether there are more than a specified number of files stored or posted on the server, in this embodiment six files, illustrated as 520. If there are less than six files on the server, the server or processor stores the file on the server, illustrated as 522. If there are more than six files on the server, the server or processor securely deletes the oldest file on the server, illustrated as 524, and the server or processor stores the file on the server, illustrated as 522.

In this embodiment, the server or processor may post the file to a subdirectory for the sender that is accessible to the sender over a network, illustrated as 526. In this embodiment, the subdirectory may be a personal website for the sender, illustrated as 528, and only allows the sender/registered user and other users identified by the sender to access the file on the website.

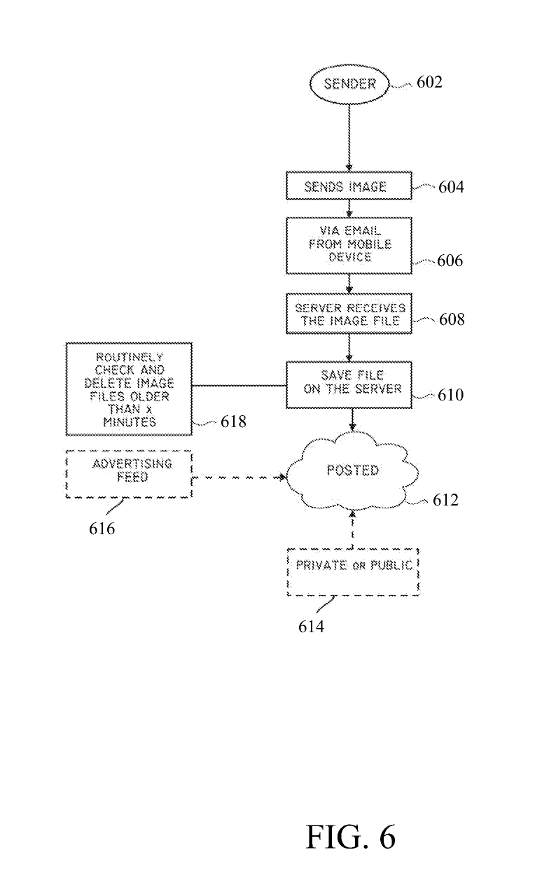

A flow diagram of processing and deleting files based on a specified time limit according to an illustrative embodiment is described with reference to FIG. 6. As illustrated in FIG. 6, a sender 602 may send a file, for example, an image, illustrated as 604, to the server. In this embodiment, the sender 602 sends the file in an email communication from a local device, for example, a mobile device, illustrated as 606. The server receives the file, illustrated as 608. The server or processor may also open the email communication and collect only the file in the email communication. The email communication may be discarded, or securely deleted after the file has been collected.

The server or processor stores or posts the file on the server, illustrated as 610. The server or processor may also post the file to a website, illustrated as 612. The website may allow private or public access to the website by users, illustrated as 614. When the website is private, the website may require a user to log into the website in order to access the website and view or download the submitted file. In some embodiments, the website may receive and include advertising materials that are also posted on the website, illustrated as 616.

In this embodiment, the server or processor continuously or periodically determines how long each file stored or posted on the server has been on the server, and securely deletes each file stored or posted on the server beyond a specified time limit, illustrated as 618. The time limit may be, for example, a number of minutes, hours, days, weeks, etc.

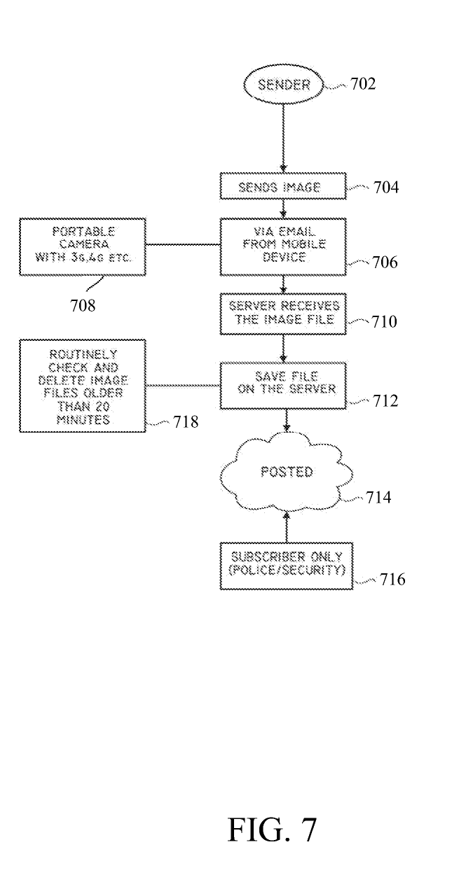

A flow diagram of a subscriber based application and deleting files based on a specified time limit according to an illustrative embodiment is described with reference to FIG. 7. As illustrated in FIG. 7, a sender 702 may send a file, for example, an image, illustrated as 704, to the server in an email communication from a local device, for example, a mobile device, illustrated as 706. In this embodiment, the email communication may include a photograph from a portable camera and be sent to the server over a mobile phone communication network, for example, a 3G network, 4G network, etc., illustrated as 708. The server receives the file, illustrated as 710, and the server or processor stores or posts the file on the server, illustrated as 712. The server or processor may open the email communication and collect only the file in the email communication. The email communication may be discarded or securely deleted.

The server or processor may also post the file to a website or database, illustrated as 714. In this embodiment, the website is a private website or private database and only allows subscribers or registered users to access the posted files, illustrated as 716, for example, by entering secure login information. This may be desirable in a police security application in which senders may submit photographs and other files of suspicious or criminal activity anonymously. Further, as described above, the server or processor also continuously or periodically determines how long each file stored or posted on the server has been on the server, and securely deletes each file stored or posted on the server beyond a specified time limit, illustrated as 718.

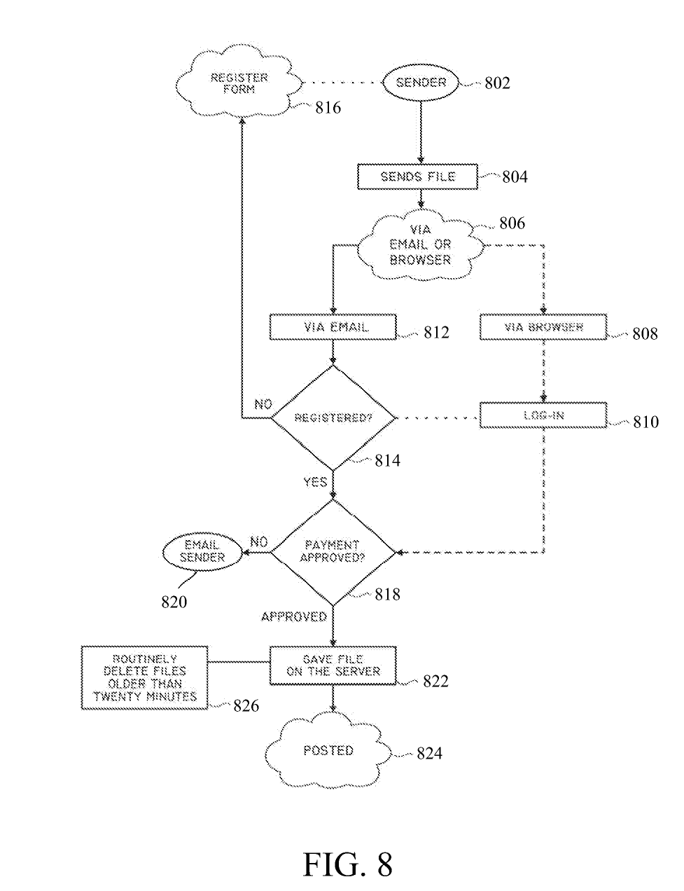

A flow diagram of a paid-for file sharing application and deleting files based on a specified time limit according to an illustrative embodiment is described with reference to FIG. 8. This application may be useful for restaurants, posting of classified ads, and time sensitive advertisements. As illustrated in FIG. 8, a sender 802 may send a file, illustrated as 804, to the server in an email communication from a local device or via browser or website, illustrated as 806. When the file is sent via a browser, illustrated as 808, the server or processor may require the sender to log into the server, illustrated as 810.

When the file is sent via an email, illustrated as 812, the server or processor determines whether the sender is a registered user or sender, illustrated as 814, for example, by determining whether the email address that the email communication was sent from is registered under an account. If the sender is not registered and/or does not have a login, the server or processor may prompt the sender to register by filling out a registration form, illustrated as 816.

When the sender is registered and/or has a login, the server or processor determines whether the sender's payment method on file is approved or processes in response to an electronic payment, illustrated as 818. If the payment is not approved, the server or processor may send an email notification to the sender, illustrated as 820. If the payment is approved, the server or processor receives the file sent by the sender and stores the file on the server, illustrated as 822. The server or processor may also post the file to a website or database, illustrated as 824. Further, as described above, the server or processor also continuously or periodically determines how long each file stored or posted on the server has been on the server, and securely deletes each file stored or posted on the server beyond a specified time limit, in this embodiment the time limit is thirty minutes, illustrated as 826. However, as described above the time limit may be any number of minutes, hours, days, weeks, months, etc.

While the systems and methods have been described and illustrated in connection with certain embodiments, many variations and modifications will be evident to those skilled in the art and may be made without departing from the spirit and scope of the present disclosure. The present disclosure is thus not to be limited to the precise details of methodology or construction set forth above as such variations and modification are intended to be included within the scope of the present disclosure.

In one aspect, the file submitted can be a screen capture, a digital photograph or digital video (for example, taken from a digital camera, digital video camera, a mobile device, such as a smart phone, and other devices of the type), a document, a digital image file, or other file of the type. Further, while certain features have been described in connection with certain embodiments, any of the embodiments may incorporate or include any of the features disclosed herein. The sender or the user may act as an administrator to define the rules for when a file is securely deleted. For example, in the police security application, a police department administrator may be permitted to define the rules for when files or other information is securely deleted. In restaurant, classified ad, and time sensitive advertisement applications, the restaurant or sender of the ad/advertisement may act as an administrator to set the rules for how long the file is posted before being deleted. The system may also be operated by a third party, in which case a third party administrator determines the rules based on, among other things, the third party's own preferences or customer instructions.

The local device may be a personal computer, a laptop computer, a cellular phone, a personal digital assistant (PDA), a tablet computer, and other desktop or mobile device of the type. The embodiments disclosed herein may be implemented as a computer implemented method, a system, or as an article of manufacture such as a memory device or non-transitory computer readable storage medium. The computer readable storage medium may be readable by a computer and may comprise instructions for causing a computer or other device to perform processes described in the present disclosure. The computer readable storage medium may be implemented by a volatile computer memory, non-volatile computer memory, hard drive, solid state memory, flash drive, removable disk, and/or other media.

Communications between components in the systems and methods disclosed herein may be unidirectional or bidirectional electronic communication through a wired or wireless configuration or network. For example, one component may be wired or networked wirelessly directly or indirectly, through a third party intermediary, over the Internet, or otherwise with another component to enable communication between the components. Examples of wireless communications include, but are not limited to, radio frequency (RF), infrared, Bluetooth, wireless local area network (WLAN) (such as WiFi), or wireless network radio, such as a radio capable of communication with a wireless communication network such as a Long Term Evolution (LTE) network, WiMAX network, 3G network, 4G network, and other communication networks of the type.

The embodiments disclosed herein may be performed in different forms of software, firmware, and/or hardware. The embodiments disclosed herein may be performed on a single device or may be performed on multiple devices. For example, program modules including one or more components described herein may be located in different devices and may each perform one or more aspects of the present disclosure. As used in this disclosure, the term “a” or “one” may include one or more items unless specifically stated otherwise. Further, the phrase “based on” is intended to mean “based at least in part on” unless specifically stated otherwise. Moreover, unless specifically stated any use of the terms first, second, etc. do not denote any order or importance, but rather the terms first, second, etc. are merely used to distinguish one element from another.

What is claimed is:

1. A system for temporarily storing files, comprising:
at least one computer configured to:
receive a file;
store the file on the at least one computer;
allow the file to be accessed over a network; and
securely delete the file when a rule defining when the file is to be securely deleted has been satisfied.

2. The system of claim 1, wherein the rule is defined by a specified time limit.

3. The system of claim 1, wherein the rule is defined by a specified number of files.

4. The system of claim 1, wherein securely deleting the file includes overwriting the file with random data.

5. The system of claim 1, wherein the computer is further configured to delete information identifying the source of the file.

6. The system of claim 1, wherein the file is at least one of a photograph, a coupon, an advertisement, and a news article.

7. A method of temporarily storing files, comprising:
receiving, by at least one computer, a file over a network;
storing the file in a database;
posting the file; and
securely deleting the file when a rule defining when the file is to be securely deleted has been satisfied.

8. The method of claim 7, further comprising allowing the file to be downloaded from a website.

9. The method of claim 7, further comprising limiting access to the file.

10. The method of claim 7, wherein securely deleting the file includes securely deleting the file when a specified time limit is satisfied.

11. The method of claim 7, wherein securely deleting the file includes securely deleting the file when a rule defining a specified number of files is satisfied.

12. The method of claim 7, wherein securely deleting the file includes overwriting the file with random data.

13. The method of claim 7, further comprising deleting information identifying the source of the file.

14. The method of claim 7, further requiring the file to be received from a registered sender.

15. The method of claim 7, further comprising allowing an administrator to define the rule.

16. A system for temporarily storing files, comprising:
at least one computer including a processor configured to:
receive an email communication;
open the email communication;
collect the file from the email communication;
store the file; and
securely delete the file when a rule defining when the file is to be securely deleted has been satisfied.

17. The system of claim 16, wherein the rule is defined by a specified time limit.

18. The system of claim 16, wherein the rule is defined by a specified number of files.

19. The system of claim 16, wherein the rule is defined by an administrator.

20. The system of claim 16, wherein the processor is further configured to post the file on a website.
